(19) United States
(12) Patent Application Publication
(10) Pub. No.: US 2005/0289337 A1
(43) Pub. Date: Dec. 29, 2005

(54) Electronic mail server device and electronic mail processing method

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/157,826

(22) Filed: Jun. 22, 2005

(30) Foreign Application Priority Data
Jun. 24, 2004 (JP) 2004-185928

(51) Int. Cl. H04L 9/00

(52) U.S. Cl. 713/151

(57) ABSTRACT

An advantage of the present invention is to prevent a load from being placed on a terminal during a processing at transmission or reception of data and to secure safety in communication. An electronic mail server device extracts transmission destination information from received electronic mail, and in accordance with the extracted transmission destination information, executes an encryption processing on the electronic mail and transmits the electronic mail. The electronic mail server device includes an encryption processing determination unit, an encryption processing database and an encryption processing unit, which are a communication data creating unit for creating communication data, and a transmission unit, which transmits the created communication data. An electronic mail server device extracts transmitter information from received electronic mail, and in accordance with the extracted transmitter information, executes a decryption processing on the electronic mail and stores the decrypted electronic mail in a mailbox.

### BACKGROUND OF THE INVENTION

1. Field of the Invention

The present invention relates to an electronic mail server device, and in particular, relates to an electronic mail server device and an electronic mail processing method which encrypt electronic mail before transmission by a prescribed method or decrypt electronic mail after reception.

2. Description of Related Art

According to a technology which encrypts electronic mail and transmits the encrypted electronic mail to another terminal through the Internet, an encryption processing is executed on data, electronic mail having the encrypted data as an attached file is created and the created electronic mail is transmitted to a remote device.

Meanwhile, in general, when encrypting the electronic mail, an encryption processing is executed in accordance with a program handled in an application layer of a communication protocol, for example, the Secure/Multipurpose Internet Mail Extension (S/MIME). By executing such an encryption processing, safety of the electronic mail at the transmission and the reception can be improved.

While a demand exists for an improvement in the safety at the transmission and the reception of the electronic mail, since an advanced encryption processing like the S/MIME places a load on a memory of a device, there has been a demand for an electronic mail terminal device which can reduce such a load.

### SUMMARY OF THE INVENTION

The present invention has been made in consideration of the above-described circumstances. An advantage of the present invention is to provide an electronic mail server device for an electronic mail system, which prevents a load from being placed on a terminal during a processing at transmission or reception of electronic mail and is capable of securing safety in communication, and an electronic mail processing method of the electronic mail server device.

According to an aspect of the present invention, an electronic mail server device includes an address extracting unit, a communication data creating unit and a transmission unit. The address extracting unit extracts a transmission destination address from received electronic mail. The communication data creating unit determines whether or not to execute an encryption processing on the electronic mail in accordance with the extracted transmission destination address. When the communication data creating unit determines to execute the encryption processing, the communication data creating unit decides under which method the encryption processing will be executed, executes the encryption processing on the electronic mail under the decided method and creates communication data. The transmission unit transmits the created communication data.

In the electronic mail server device, the communication data creating unit includes an encryption processing database in which a transmission destination address and information relating to an encryption processing of electronic mail having the transmission destination address are accumulated by being associated with one another. The communication data creating unit decides whether or not to execute the encryption processing and an encryption method by referring to the encryption processing database.

According to the above-described aspect, the transmission destination address is extracted from the received electronic mail by the address extracting unit. Furthermore, after the communication data creating unit determines whether or not to execute the encryption processing in accordance with the extracted transmission destination address, the encryption processing is executed according to necessity and the communication data is obtained. In this case, the encryption method can be set according to a level of safety required by an electronic mail address or a domain. The obtained communication data is transmitted from the transmission unit to a network such as the Internet and is transmitted eventually to an electronic mail server device connected to a client terminal of a transmission destination.

Since a decision is made as to whether or not to execute the encryption processing and the encryption method by referring to the encryption processing database, in case of making a change relating to the encryption processing, the change can be made just by updating accumulated data in the encryption processing database without changing a hardware configuration. As a result, a system can be changed easily.

According to another aspect of the present invention, an electronic mail server device includes a reception unit, an electronic mail processing unit and a mailbox. The reception unit receives communication data. The electronic mail processing unit extracts encrypted electronic mail from electronic mail obtained from the received communication data and decrypts the extracted electronic mail. The mailbox temporarily stores the electronic mail obtained by the electronic mail processing unit. In addition, according to a request from a recipient client terminal, the mailbox transmits the stored electronic mail to the client terminal.

According to the above-described aspect, communication data transmitted from a remote device is received by the reception unit. The electronic mail processing unit obtains electronic mail from the received communication data, and in particular, executes a decryption processing on the encrypted electronic mail and transmits the electronic mail to a mailbox corresponding to a transmission destination address. The mailbox temporarily stores the electronic mail and in case of receiving a request from the client terminal, transmits the electronic mail to the client terminal.

According to the present invention, an encryption processing and a decryption processing of the electronic mail are executed by the electronic mail server device. As a result, a load is prevented from being placed on a terminal during a processing at transmission or reception of the data and safety in the communication can be secured.

### BRIEF DESCRIPTION OF THE SEVERAL VIEWS OF THE DRAWINGS

FIG. 1 shows an electronic mail network system according to an embodiment of the present invention.

FIG. 2 is a functional block diagram of an electronic mail server device according to an embodiment of the present invention.

FIG. 3 shows an example of the content of an encryption processing database according to an embodiment of the present invention.

FIG. 4 is a flowchart showing an operation according to an embodiment of the present invention.

FIG. 5 is a functional block diagram of an electronic mail server device according to an embodiment of the present invention.

FIG. 6 is a flowchart showing an operation according to an embodiment of the present invention.

### DETAILED DESCRIPTION OF THE INVENTION

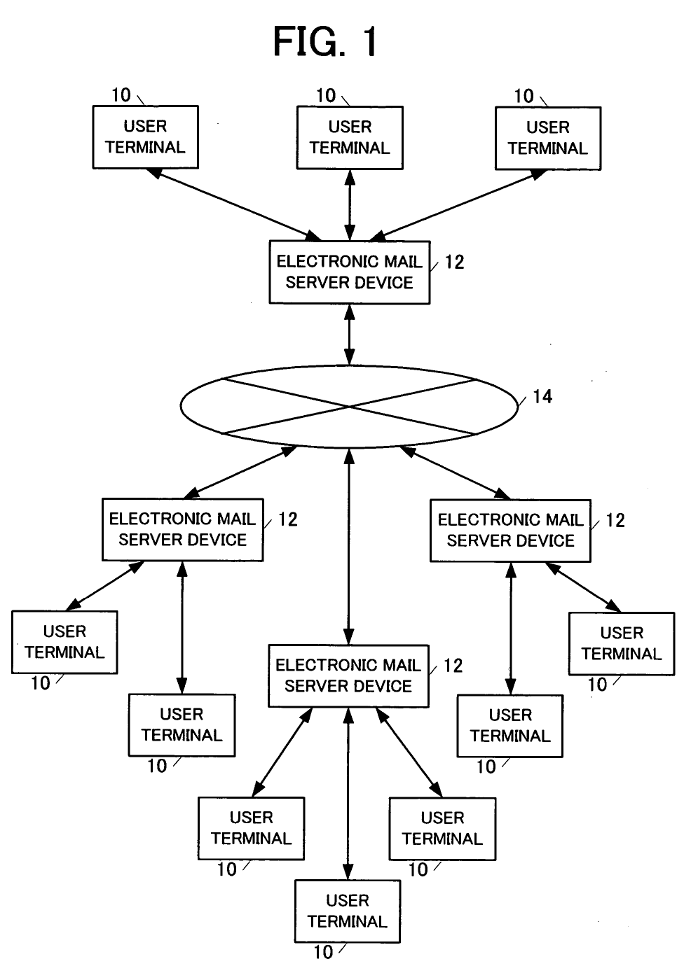

With reference to the drawings, an embodiment of the present invention will be described. FIG. 1 shows an electronic mail network system formed by using an electronic mail server device according to an embodiment of the present invention.

In the electronic mail network system, a plurality of electronic mail server devices 12 are respectively connected via the Internet 14 as a network. At least one user terminal 10 as a client terminal is connected to each of the electronic mail server devices 12. The electronic mail server device 12 transmits and receives electronic mail through the Internet 14.

In the user terminal 10, a command operation or the like relating to creating, displaying, transmitting and receiving of electronic mail is carried out.

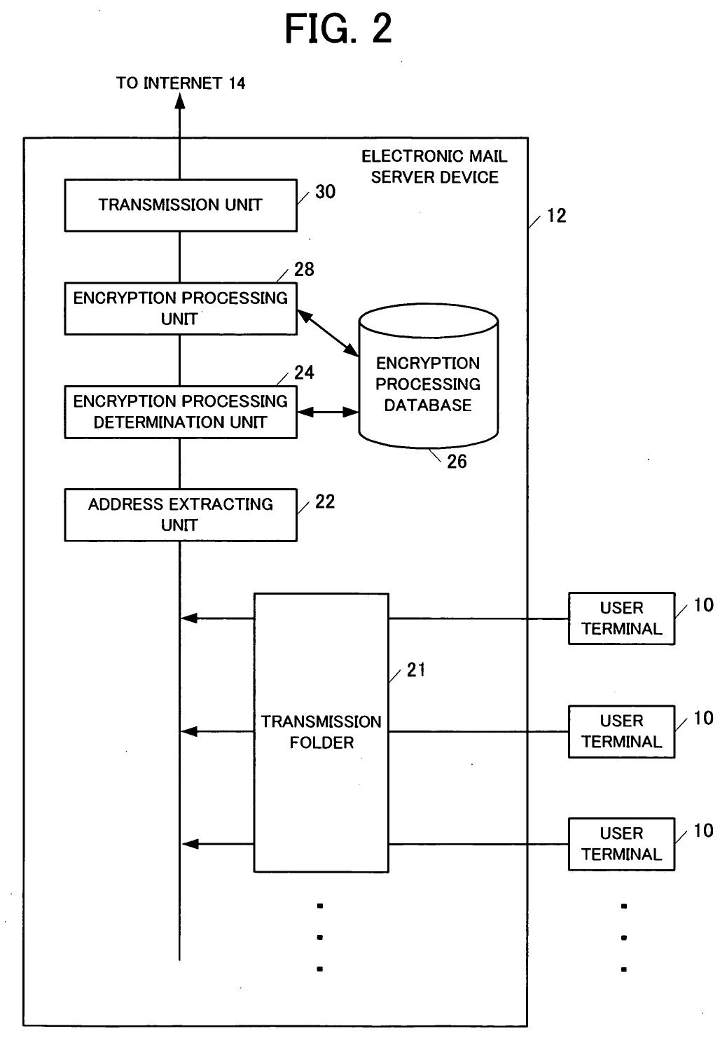

FIG. 2 is a functional block diagram of the electronic mail server device 12 at transmission of the electronic mail. The electronic mail server device 12 includes a transmission folder 21, an address extracting unit 22, an encryption processing determination unit 24, an encryption processing database 26 and an encryption processing unit 28 as a communication data creating unit, and a transmission unit 30.

The transmission folder 21 receives electronic mail created by the user terminal 10 and transmits the electronic mail to the address extracting unit 22.

The address extracting unit 22 extracts a transmission destination address from the electronic mail received from the transmission folder 21.

By referring to the encryption processing database 26 in accordance with the extracted transmission destination address, the encryption processing determination unit 24 determines whether or not to execute an encryption processing, in other words, whether or not the electronic mail is a subject of an encryption processing. When the encryption processing determination unit 24 determines to execute the encryption processing, the encryption processing determination unit 24 decides under which method the encryption processing will be executed.

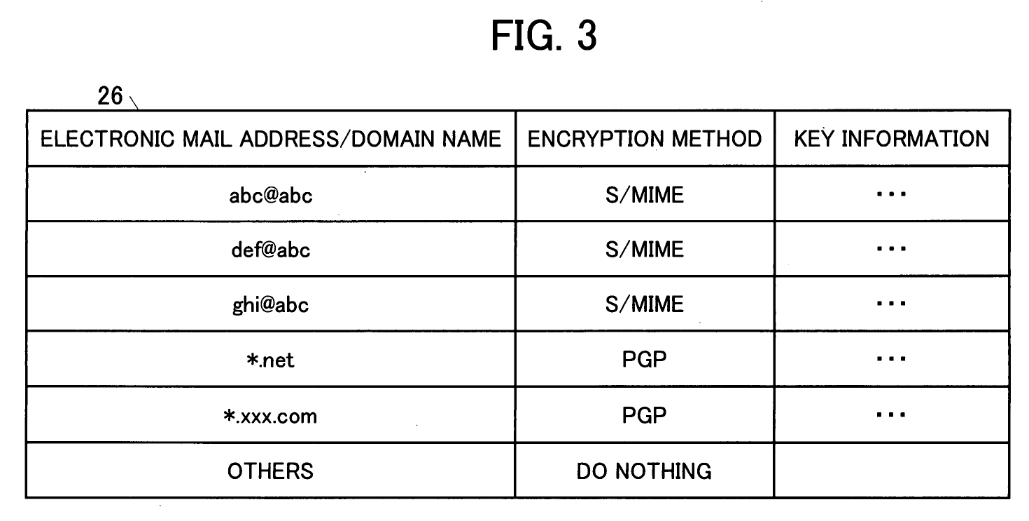

As shown in FIG. 3, in the encryption processing database 26, an electronic mail address or a domain name and information relating to the encryption processing are accumulated by being associated with one another. For example, the “S/MIME” method is associated with electronic mail addresses “abc@abc”, “def@abc” and “ghi@abc”, and the “Pretty Good Privacy (PGP)” method is associated with domain names “*.net” and “*.xxx.com”. For the other electronic mail addresses and domain names, “do nothing” is associated. Furthermore, the encryption processing database 26 stores a parameter necessary for an encryption processing and a decryption processing such as key information. In case of using the encryption processing database 26 for transmission (encryption), the encryption processing database 26 stores public key information of a transmission destination for each electronic mail address or each domain name of the transmission destination.

As described above, the encryption processing determination unit 24 decides whether or not to execute the encryption processing and the encryption method by referring to the encryption processing database 26. Accordingly, when making a change relating to the encryption processing, the change can be made just by updating accumulated data in the encryption processing database 26 without changing a hardware configuration. As a result, the system can be changed easily.

Referring to FIG. 2 again, in the encryption processing unit 28, an encryption processing is executed on the electronic mail by the encryption method and the public key decided by the encryption processing determination unit 24 and communication data is created. When the encryption processing is executed, a parameter necessary for the encryption processing is referenced from the encryption processing database 26. Moreover, when the encryption processing determination unit 24 determines not to execute the encryption processing, communication data is created without executing the encryption processing on the electronic mail.

In the transmission unit 30, the created communication data is transmitted through the Internet 14 and eventually transmitted to the electronic mail server device 12 connected to a client terminal of the transmission destination (a transmission passage is not shown). Further, the transmission of the communication data can be carried out sequentially, however, the transmission of the communication data can be carried out at a point of time when a certain number of communication data is accumulated.

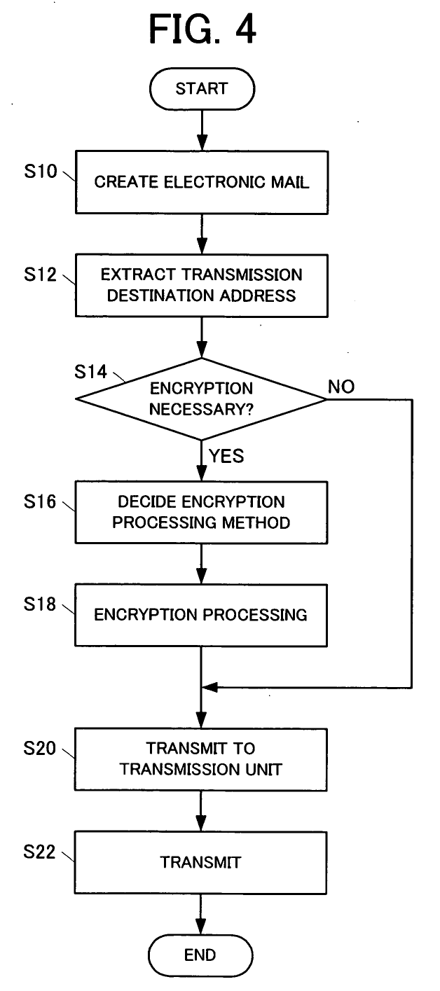

FIG. 4 is a flowchart showing an operation procedure of each structure at the transmission of the electronic mail. Further, among the structures shown in FIG. 2, for a structure relating to an operation of each step, a reference numeral will be cited appropriately and a description will be made.

At step S10, the user terminal 10 creates electronic mail. At step S12, the created electronic mail is transmitted to the address extracting unit 22 via the transmission folder 21 and a transmission destination address is extracted from information of an envelope part or a header part.

At step S14, in accordance with the electronic mail address or the domain of the transmission destination extracted at step S12, by referring to the encryption processing database 26 having the data as shown in FIG. 3, the encryption processing determination unit 24 determines whether or not an encryption processing is necessary for the electronic mail to be transmitted to the client terminal specified by the extracted electronic mail address of the transmission destination.

When the determination result at step S14 is NO, in other words, when a determination is made that an encryption processing is not necessary, the process proceeds onto step S20. When the determination result at step S14 is YES, in other words, when a determination is made that an encryption processing is necessary to be executed on the electronic mail, the process proceeds onto step S16. At step S16, by continuing to refer to the encryption processing database 26, the encryption processing determination unit 24 decides under which method the encryption processing will be executed.

At step S18, the encryption processing unit 28 executes the encryption processing on the electronic mail by the encryption processing method decided at step S16. That is, the electronic mail is encrypted by using the encryption method and the public key obtained by referring to the encryption processing database 26 for the electronic mail address or the domain of the transmission destination extracted at step S12.

Next, at step S20, the electronic mail, which has been encrypted, or the electronic mail, which did not require the encryption processing, is processed and communication data is obtained. This communication data is transmitted to the transmission unit 30. At step S22, the communication data transmitted to the transmission unit 30 is transmitted through the Internet 14 and the transmission operation ends. This electronic mail is transmitted eventually to another electronic mail server device 12 via various passages in some cases.

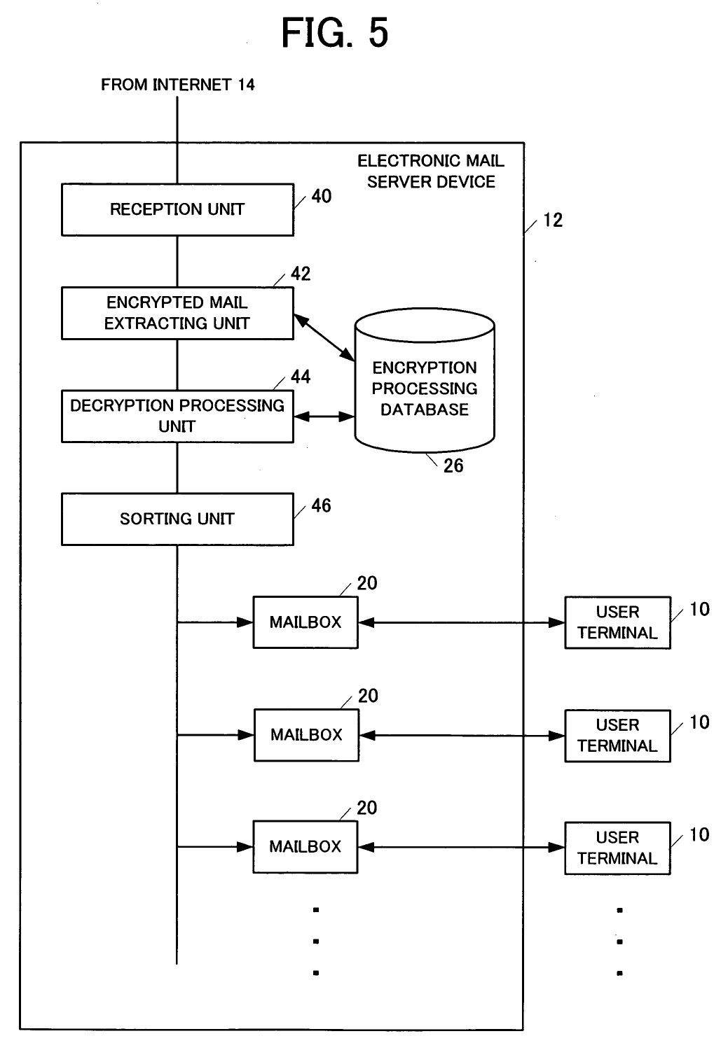

FIG. 5 is a functional block diagram of the electronic mail server device 12 at reception of the electronic mail. The electronic mail server device 12 includes a reception unit 40, an encrypted mail extracting unit 42, a decryption processing unit 44 and an encryption processing database 26 as an electronic mail processing unit, a sorting unit 46 and mailboxes 20. When the encryption processing database 26 is used for the reception (decryption), the encryption processing database 26 stores secret key information of the transmitter for each electronic mail address or each domain name of the transmitter.

The reception unit 40 receives the communication data transmitted via the Internet 14.

The encrypted mail extracting unit 42 obtains electronic mail from the communication data received by the reception unit 40 and extracts encrypted electronic mail from this electronic mail. Further, the electronic mail, which has not been extracted, can be transmitted directly to the sorting unit 46 to be described later or can be transmitted once to the decryption processing unit 44 and then to the sorting unit 46 without executing a processing in the decryption processing unit 44.

The decryption processing unit 44 executes a decryption processing on the encrypted data while referring to the encryption processing database 26 for a parameter necessary for the encryption processing according to necessity.

The sorting unit 46 obtains a transmission destination address from the information of an envelope part or a header part of the electronic mail transmitted from the decryption processing unit 44 and in some cases, the electronic mail transmitted from the encrypted mail extracting unit 42. Then, the sorting unit 46 transmits the electronic mail to the mailbox 20 corresponding to the obtained transmission destination address.

The mailbox 20 temporarily stores the obtained electronic mail. According to a request from the user terminal 10 as a recipient client terminal, the mailbox 20 transmits the stored electronic mail to the user terminal 10 which made the request.

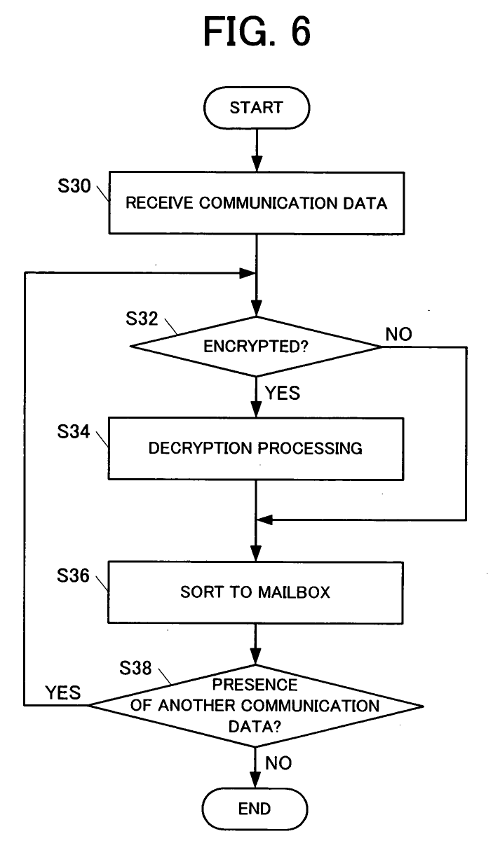

FIG. 6 is a flowchart showing an operation procedure of each structure at the reception of the electronic mail. Further, among the structures shown in FIG. 5, for a structure relating to an operation of each step, a reference numeral will be cited appropriately and a description will be made.

At step S30, the reception unit 40 receives the communication data transmitted through the Internet 14.

At step S32, the encrypted mail extracting unit 42 determines whether or not the electronic mail obtained from the received communication data is encrypted.

When the determination result at step S32 is NO, in other words, when a determination is made that the electronic mail is not encrypted, the process proceeds onto step S36 and the electronic mail is transmitted from the sorting unit 46 to the corresponding mailbox 20.

When the determination result at step S32 is YES, in other words, when a determination is made that the electronic mail is encrypted, the process proceeds onto step S34 and the decryption processing unit 44 executes the decryption processing on the electronic mail. Then, the process proceeds onto step S36 and the electronic mail is transmitted from the sorting unit 46 to the corresponding mailbox 20. That is, at step S34, the electronic mail is decrypted by using the encryption method and the secret key obtained by referring to the encryption processing database 26 for the electronic mail address or the domain of the transmitter.

At step S38, a determination is made as to whether or not unprocessed communication data still exists in the reception unit 40. In case a determination result at step S38 is YES, in other words, in case of the presence of unprocessed communication data, the process returns to step S32. In case a determination result at step S38 is NO, in other words, in case of the absence of unprocessed communication data, the reception operation ends.

As described above, according to an embodiment of the present invention, the encryption and the decryption of the electronic mail for securing safety required in the network can be executed by the electronic mail server device. Therefore, even when an operator of the client terminal cannot handle the encryption, the operator can just carry out a general electronic mail operation. Moreover, since the encryption processing and the decryption processing of the electronic mail are executed by the electronic mail server device, a load is prevented from being placed on the terminal during the processing at the transmission or the reception of the data and the safety in the communication can be secured.

Further, although an embodiment of the present invention has been described, the present invention is not limited to the above-described embodiment. For example, as the encryption method of the electronic mail, the public key encryption method such as the S/MIME and the PGP has been described. However, another encryption method can be used. Moreover, the encryption method has been selected from two types of encryption methods. However, the present invention is not limited to this example, and the encryption method can be selected from three types or more of encryption methods. Moreover, a common key (secret key) encryption method such as the Data Encryption Standard (DES) can be used. In this case, a common key (secret key) to be stored in the encryption processing database is preferable to be a common key unique for each combination of a transmitter and a transmission destination.

Moreover, in the above-described embodiment, the encryption processing database is provided and by referring to the content of the encryption processing database, a determination is made as to whether or not to execute the encryption processing of the electronic mail and in case of executing the encryption processing, the encryption method is decided. However, the present invention is not limited to this example. By previously deciding an encryption method according to an end of a domain or a format of an address, the database to be referenced becomes unnecessary.

1. An electronic mail server device, comprising:
an address extracting unit which extracts transmission destination information from received electronic mail;
a communication data creating unit which determines whether or not to execute an encryption processing on the electronic mail in accordance with the extracted transmission destination information, and when said communication data creating unit determinates to execute the encryption processing, said communication data creating unit decides a method for executing the encryption processing, executes the encryption processing on the electronic mail by the decided method and creates communication data; and
a transmission unit which transmits the created communication data.

2. The electronic mail server device according to claim 1, wherein the communication data creating unit includes an encryption processing database in which the transmission destination information is associated with information relating to the encryption processing of the electronic mail having the transmission destination information, and
by referring to the encryption processing database, the communication data creating unit decides whether or not to execute the encryption processing, the encryption method and a public key.

3. The electronic mail server device according to claim 1, wherein the transmission destination information is an electronic mail address of a transmission destination.

4. The electronic mail server device according to claim 1, wherein the transmission destination information is a domain name of an electronic mail address of a transmission destination.

5. The electronic mail server device according to claim 2, wherein the transmission destination information is an electronic mail address of a transmission destination.

6. The electronic mail server device according to claim 2, wherein the transmission destination information is a domain name of an electronic mail address of a transmission destination.

7. An electronic mail server device, comprising:
a reception unit which receives communication data;
an electronic mail processing unit which extracts encrypted electronic mail from electronic mail obtained from the received communication data and decrypts the extracted electronic mail; and
a mailbox which temporarily stores the electronic mail obtained by the electronic mail processing unit and according to a request from a client terminal of a recipient, transmits the stored electronic mail to the client terminal.

8. The electronic mail server device according to claim 7, wherein the electronic mail processing unit includes an encryption processing database in which transmitter information of the electronic mail is associated with information relating to a decryption processing of the electronic mail having the transmitter information, and
by referring to the encryption processing database, the electronic mail processing unit decides an encryption method and a secret key.

9. The electronic mail server device according to claim 8, wherein the transmitter information is an electronic mail address of a transmitter.

10. The electronic mail server device according to claim 8, wherein the transmitter information is a domain name of an electronic mail address of a transmitter.

11. An electronic mail processing method, comprising:
a receiving step of receiving communication data;
a decrypting step of extracting encrypted electronic mail from electronic mail obtained from the received communication data and decrypting the extracted electronic mail;
a storing step of temporarily storing the decrypted electronic mail; and
a transmitting step of transmitting the stored electronic mail to a client terminal of a recipient according to a request from the client terminal.

12. The electronic mail processing method according to claim 11, wherein the decrypting step decides an encryption method and a secret key in accordance with an encryption processing database in which transmitter information of the electronic mail is associated with information relating to a decryption processing of the electronic mail having the transmitter information.

13. The electronic mail processing method according to claim 12, wherein the transmitter information is an electronic mail address of a transmitter.

14. The electronic mail processing method according to claim 12, wherein the transmitter information is a domain name of an electronic mail address of a transmitter.
